(19) United States
(12) Patent Application Publication
(10) Pub. No.: US 2026/0366993 A1
(43) Pub. Date: Nov. 19, 2026

(54) SYSTEMS, METHODS, AND APPARATUS FOR ANALYZING MULTIMODAL MEASUREMENT DATA TO PROFILE SAMPLES

(71) Applicant: HyperSpectral Corp., Alexandria, VA (US)

(72) Inventors: Euan F. MOWAT, Alexandria, VA (US); Matthew THEURER, Alexandria, VA (US); Logan SPEARS, Kingston, WA (US)

(21) Appl. No.: 19/631,993

(22) Filed: Mar. 27, 2026

Related U.S. Application Data
(63) Continuation-in-part of application No. 19/457,662, filed on Jan. 23, 2026.
(60) Provisional application No. 63/749,464, filed on Jan. 24, 2025.
(60) Provisional application No. 63/781,298, filed on Mar. 31, 2025.

(51) Int. Cl. G01N 21/31; G01N 21/65; G06N 3/0464

(52) U.S. Cl. CPC G01N 21/31; G01N 21/65; G06N 3/0464

(57) ABSTRACT

According to an embodiment, a non-transitory, processor-readable medium stores instructions that, when executed by a processor, cause the processor to detect that at least one measurement device from a plurality of measurement devices is coupled to an apparatus. In response to detecting the at least one measurement device, a control signal is sent to an actuator of the apparatus, based on the at least one measurement device, to cause a sample to move within a field of view of the at least one measurement device. In response to sending the control signal, measurement data of the sample is received from the at least one measurement device. The instructions further cause the processor to classify the sample based on dominant spectral variation data.

### CROSS REFERENCE TO RELATED APPLICATIONS

This application claims priority to and the benefit of U.S. Provisional Application No. 63/781,298, filed Mar. 31, 2025, and titled “SPECTRAL LAB IN A BOX: AN INNOVATIVE APPROACH TO A MODULAR, PORTABLE, AND LOW-COST SPECTRAL LAB IN A BOX,” which is incorporated herein by reference. This application is also a continuation-in-part of and claims priority to and the benefit of U.S. patent application Ser. No. 19/457,662, filed Jan. 23, 2026, and titled “SYSTEMS AND METHODS TO ANALYZE MULTIMODAL SPECTROSCOPY DATA TO PROFILE SAMPLES,” which claims priority to and benefit of U.S. Provisional Application No. 63/749,464, filed Jan. 24, 2025, and titled “SYSTEMS AND METHODS OF DETECTING PATHOGENS USING SPECTROSCOPY AND ARTIFICIAL INTELLIGENCE,” the contents of each of which are incorporated herein by reference.

### FIELD

One or more embodiments described herein relate to the field of spectroscopy and, more specifically, to systems, methods, and apparatus configured to analyze multimodal measurement (e.g., spectral) data to profile substances and/or pathogens.

### BACKGROUND

Detection tasks involving spectroscopy can be associated with, for example, drug detection (e.g., fentanyl detection and/or the like), bacteria detection (e.g., antibiotic-resistant bacteria detection, and/or the like), other pathogen detection (e.g., viral detection and/or the like), and/or etc.

Antibiotic-resistant bacteria, including, for example, methicillin-resistant Staphylococcus aureus (MRSA) and Mycobacterium tuberculosis (MDR-TB), represent a growing global health threat, driving significant morbidity, mortality, and healthcare expenditures. In parallel, the frequent emergence of foodborne pathogens (e.g., Listeria monocytogenes, Escherichia coli, Salmonella enterica, and/or etc.) underscores the importance of continuous, cost-effective surveillance. Unfortunately, some known detection methods are time-consuming and labor-intensive, delaying appropriate interventions. For example, molecular approaches such as 16S rRNA gene sequencing are constrained by time (e.g., due to culture and/or sequencing), cost, and/or infrastructure requirements.

More specifically, some known culture-based tests, such as biochemical assays, have historical validation and are relatively straightforward to interpret outcomes. These culture-based tests, however, can span at least one to three days to generate results, and in the case of slow-growing organisms such as Mycobacterium tuberculosis, can extend to several weeks, substantially delaying definitive treatment. Furthermore, cultures can be highly sensitive to growth conditions; even slight variations in temperature, medium composition, or incubation time can lead to false negatives, ultimately increasing the risk of underdiagnosis and/or misdiagnosis. Beyond these issues, some known culture-based testing involves considerable laboratory space and skilled personnel to oversee the lengthy incubation periods and interpret results accurately.

Other known detection methods include Matrix-Assisted Laser Desorption/Ionization Time-Of-Flight (MALDI-TOF) mass spectrometry, which identifies bacteria by analyzing the characteristic mass spectrometric profiles of proteins (often ribosomal proteins). This method is relatively rapid, typically involving about one hour after colony isolation, and can offer high species-level accuracy at a comparatively low reagent cost. Despite these advantages, however, reliable spectra depend on obtaining pure colonies and accurate organism identification depends on maintaining an up-to-date reference database.

Turning to some known nucleic-acid based methods, these methods (e.g., Polymerase Chain Reaction (PCR)) are highly sensitive and specific and are therefore useful in clinical laboratories. More specifically, Real-Time PCR (qPCR), for example, can deliver results in 2-6 hours, which is faster than traditional PCR, though primer design limitations can hinder the detection of novel strains. Next-Generation Sequencing (NGS) offers comprehensive genomic insights, but NGS's reliance on sophisticated infrastructure and higher costs typically translates to a 24-48-hour turnaround.

Yet other known detection methods include rapid immunoassays (e.g., performed by lateral flow devices), which can provide results in 15-30 minutes and are user-friendly, though these methods often target a single pathogen and exhibit modest sensitivity. Some known automated blood culture systems speed up initial detection of bloodstream infections but still depend on culture growth for definitive identification.

Turning to drug detection, the fentanyl crisis, for example, has escalated to an alarming level in the United States, causing over 100,000 annual overdose-related deaths, approximately two-thirds of which involve synthetic opioids such as fentanyl. Law enforcement can benefit from rapidly linking disparate seized synthetic opioid samples to a single source and identifying specific manufacturing routes. Some known forensic approaches involve transporting samples to a central lab and often take days or weeks to generate results. This delay severely hampers agencies like U.S. Customs and Border Protection (CBP), Immigration and Customs Enforcement (ICE), and/or etc., in on-site interdictions and/or bust operations, where contemporaneous intelligence can help disrupt active trafficking networks.

Moreover, when fentanyl (and/or the like) is seized at a border checkpoint or discovered during an on-site drug bust, agents should act quickly to pinpoint the supplier, map out the synthetic routes, and identify connections to previous seizures in other jurisdictions. Unfortunately, some known methods involve off-site laboratory infrastructure that causes critical lags before enforcement agencies can coordinate, link cases, and/or secure prosecutions. A lack of a unified cross-agency intelligence-sharing framework also complicates efforts to track evolving trafficking patterns in real time.

A need exists, therefore, for systems and methods configured to facilitate rapid and accurate detection and profiling of a sample without involving complex processes and/or infrastructure (e.g., culturing, specialized reagents, and/or etc.).

Turning to spectral devices, some known such devices are costly, bulky, (e.g., not combined in a single enclosure), and/or do not employ fusion across multiple acquisition devices. A need exists, therefore, for systems and methods that implement a “spectral lab in a box” that has modular capability to combine one or more spectral acquisition devices into a lower cost and/or portable enclosure. A further need exists for systems and methods that process measurement (e.g., spectral) data with machine learning models, such that these systems and methods can user lower cost and/or smaller acquisition devices while still achieving relatively low limits of detection that are otherwise typically achievable only by some known, more expensive/bulkier devices that moreover have only a limited set of use cases.

### SUMMARY

According to an embodiment, an apparatus includes a housing that defines an internal volume and at least two of a microscope, a spectrometer, a hyperspectral imager, or a camera, disposed within the internal volume. The apparatus further includes a processor and a non-transitory, processor-readable medium operably coupled to the processor and storing instructions that, when executed by the processor, cause the processor to receive a plurality of sets of data from the at least two of the microscope, the spectrometer, the hyperspectral imager, or the camera, each set of data from the plurality of sets of data being associated with a sample. For each set of data from the plurality of sets of data, that set of data is provided as input to at least one single-mode machine learning model to predict a single-mode feature associated with that set of data, to produce a plurality of single-mode features associated with the plurality of sets of data. The instructions further cause the processor to provide the plurality of single-mode features as input to a multimodal fusion network having a cross-attention layer to predict a cross-mode feature associated with the plurality of sets of data, and a composition of the sample is determined based on the cross-mode feature.

According to an embodiment, a non-transitory, processor-readable medium stores instructions that, when executed by a processor, cause the processor to detect that at least one measurement device from a plurality of measurement devices is coupled to an apparatus. In response to detecting the at least one measurement device, the instructions cause the processor to send a control signal to an actuator of the apparatus, based on the at least one measurement device, to cause a sample to move within a field of view of the at least one measurement device. In response to sending the control signal, the instructions cause the processor to receive measurement data of the sample from the at least one measurement device. The measurement data is provided as input to a first machine learning model to produce dominant spectral variation data having a lower dimensionality than the measurement data. The dominant spectral variation data is provided as input to a second machine learning model to produce embedded data that represents at least one feature of the measurement data, and the embedded data is provided as input to a third machine learning model to classify the sample.

According to an embodiment, an apparatus includes a plurality of measurement devices associated with a plurality of spectra, each measurement device from the plurality of measurement devices being associated with a spectrum different from remaining spectra from the plurality of spectra. The apparatus further includes a non-transitory, processor-readable medium storing instructions that, when executed by a processor, cause the processor to receive a plurality of sets of spectrum data from the plurality of measurement devices, each set of spectrum data from the plurality of sets of spectrum data associated with a sample. The instructions also cause the processor to generate a model based on at least one set of spectrum data from the plurality of sets of spectrum data. The instructions further cause the processor to perform spectral deconvolution on at least one set of spectrum data from the plurality of sets of spectrum data by (1) convolving the model based on at least one of a point spread function associated with the at least one set of spectrum data or an impulse response associated with the at least one set of spectrum data, to produce a convoluted model, and (2) producing deconvoluted spectrum data based on the convoluted model. The instructions further cause the processor to provide the deconvoluted spectrum data as input to a multimodal fusion network having a cross-attention layer to predict a cross-mode feature associated with the plurality of sets of spectrum data. A composition of the sample is determined based on the cross-mode feature.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows a system block diagram of a measurement analysis system, according to an embodiment.

FIG. 2 shows a system block diagram of a compute device included in a measurement analysis system, according to an embodiment.

FIG. 3 shows a system block diagram of a sample analysis apparatus included in a measurement analysis system, according to an embodiment.

FIG. 4 shows a system block diagram of multimodal analysis components included in a measurement analysis system, according to an embodiment.

FIG. 5 shows a system block diagram of hybrid analysis components included in a measurement analysis system, according to an embodiment.

FIG. 6 shows a confusion matrix that represents performance of a machine learning model(s) associated with a spectroscopy analysis system, according to an embodiment.

FIG. 7 shows a representation of strains of antibiotic-resistant tuberculosis bacteria analyzed by a measurement analysis system, according to an embodiment.

FIG. 8 shows a graph of Raman spectral profiles for five strains of staphylococcus aureus, according to an embodiment.

FIGS. 9A-9B show views of a sample analysis apparatus in a storage/transport configuration, the sample analysis apparatus included in measurement analysis system, according to an embodiment.

FIG. 10 shows a cutaway view of a sample analysis apparatus included in a measurement analysis system, according to an embodiment.

FIG. 11 shows a view of interfaces of a sample analysis apparatus that is included in a measurement analysis system, according to an embodiment.

FIG. 12 shows a view of a sample analysis apparatus in an operational configuration, the apparatus included in a measurement analysis system, according to an embodiment.

FIG. 13 shows an isometric view of a sample analysis apparatus included in a measurement analysis system, according to an embodiment.

FIG. 14 shows a flow diagram illustrating a method for determining a composition of a sample based on a cross-mode feature, according to an embodiment.

FIG. 15 shows a flow diagram illustrating a method for classifying a sample based on dominant spectral variation data, according to an embodiment.

FIG. 16 shows a flow diagram illustrating a method for determining a composition of a sample based on deconvoluted spectrum data, according to an embodiment.

### DETAILED DESCRIPTION

Use of spectral techniques to identify samples can involve different spectral technologies (e.g., several different spectral technologies in parallel). By combining many spectral acquisition technologies in a single device, at least some systems, methods, and apparatus described herein can address more use cases than some known devices. At least some systems, methods, and apparatus described herein moreover can be configured to promote modularity, allowing for low-, mid-, and high-entry points for users, depending on the users' specific use cases.

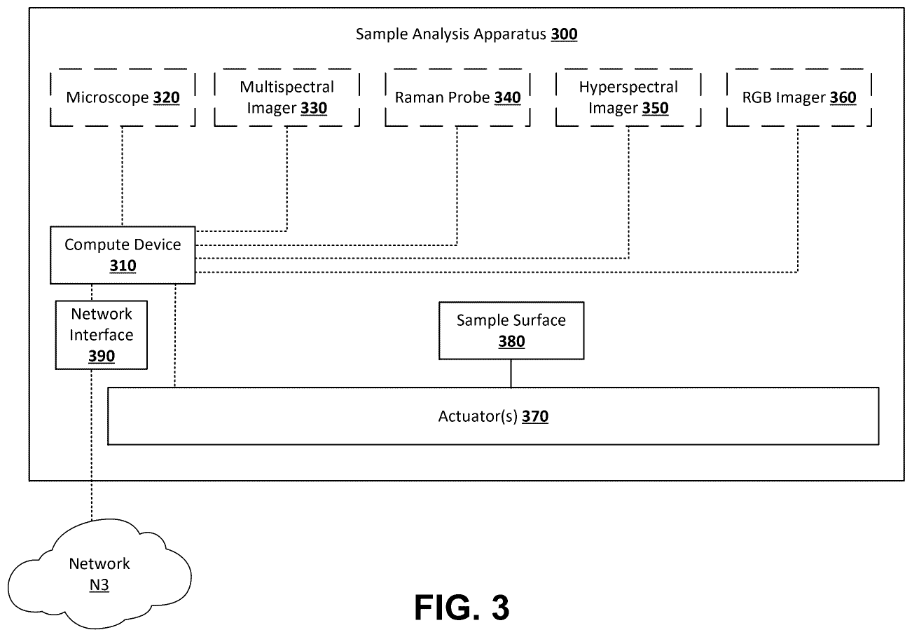

As described herein, a sample analysis apparatus (e.g., functionally and/or structurally similar to the sample analysis apparatus 300, 900, 1000, 1100, 1200, and/or 1300 described herein at least in relation to FIGS. 3, 9A-9B, 10, 11, 12, and 13, respectively) can incorporate/combine at least some of the following technologies within a single enclosure:
UV-Vis Spectroscopy (Ultraviolet-Visible);
Fluorescence Spectroscopy;
Raman/SERS/WERS/Spectroscopy, etc.;
Infrared (IR) Spectroscopy;
Fourier Transform Infrared (FTIR);
Near-Infrared (NIR), Mid-Infrared (MIR), Far-Infrared (FIR);
X-ray Spectroscopy;
Hyperspectral Imaging (HSI) & Hyperspectral Spectroscopy;
RGB Imaging;
Microscopy;
and/or the like.

One or more of the above spectral technologies can be modularized and installed or removed from the sample measurement apparatus (also referred to herein as a “spectral lab in a box”). The sample measurement apparatus can therefore be analogous to a personal computer (PC) having various slots for various modular and/or swappable components (e.g., a graphics card, network interface card, drive bays, etc.).

In some embodiments, it will be appreciated that the sample analysis apparatus can be modularized such that the sample analysis apparatus can accommodate/combine one or more modularized components within the same housing (e.g., within an internal volume(s) defined by the housing of the sample analysis apparatus). In some embodiments, the housing of the sample analysis apparatus can have different positions to allow for modularized components to be held and retained. For example, the walls and/or structural members of the housing can be positioned and configured to retain edges, straps, and/or members of the modularized components, such that the sample analysis apparatus can correctly position (e.g., relative to a sample disposed within the housing) and/or hold in place the modularized components. In some implementations, each modularized component can have a similar/consistent mating interface, such that the modularized components can be interchanged within the housing. In some embodiments, modularized components can support multiple service/maintenance instances and/or can be repositioned and/or replaced to facilitate upgrades, more advanced services, different services, and/or modularization, allowing for scalability (e.g., “future proofing”) and flexibility as a result.

As described herein, a modularized component can include circuitry and/or components to support, for example, one or more of the following:
UV-Vis Spectroscopy (Ultraviolet-Visible)
Fluorescence Spectroscopy
Raman/SERS/WERS/Spectroscopy, etc.
Infrared (IR) Spectroscopy
Fourier Transform Infrared (FTIR)
Near-Infrared (NIR), Mid-Infrared (MIR), Far-Infrared (FIR)
X-ray Spectroscopy
Hyperspectral Imaging & Hyperspectral Spectroscopy
RGB Imaging
Microscopy

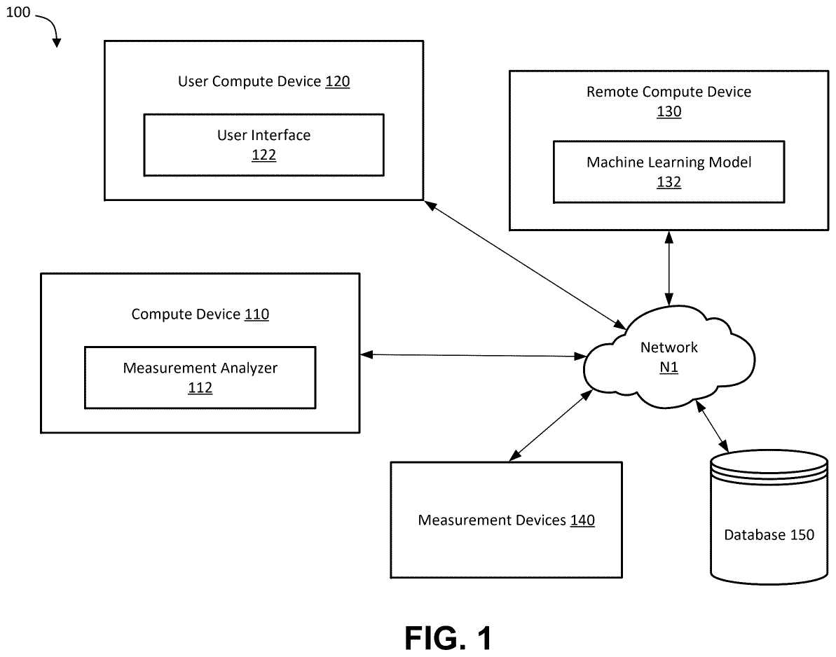

FIG. 1 shows a system block diagram of a measurement analysis system 100, according to an embodiment. The measurement analysis system 100 includes a compute device 110, a compute device 120, a remote compute device 130, measurement devices 140, an analysis database 150, and a network N1. The measurement analysis system 100 can include alternative configurations, and various steps and/or functions of the processes described below can be shared among the various devices of the measurement analysis system 100 or can be assigned to specific devices (e.g., the compute device 110, the compute device 120, the remote compute device 130, and/or the like) different from the descriptions herein. For example, in some configurations, a user can provide inputs (as described herein) directly to the compute device 110 rather than via the compute device 120.

In some implementations, the compute device 110, the compute device 120, and/or the remote compute device 130 can include any suitable hardware-based computing devices and/or multimedia devices, such as, for example, a server, a desktop compute device, a smartphone, a tablet, a wearable device, a laptop and/or the like. In some implementations, the compute device 110, the compute device 120, and/or the remote compute device 130 can be implemented at an edge (e.g., with respect to the network N1) node or other remote (e.g., with respect to the network N1) computing facility and/or device. In some implementations, each of the compute device 110, the compute device 120, and/or the remote compute device 130 can be (or be included in) a data center or other control facility and/or device configured to run and/or execute a distributed computing system and can communicate with other compute devices.

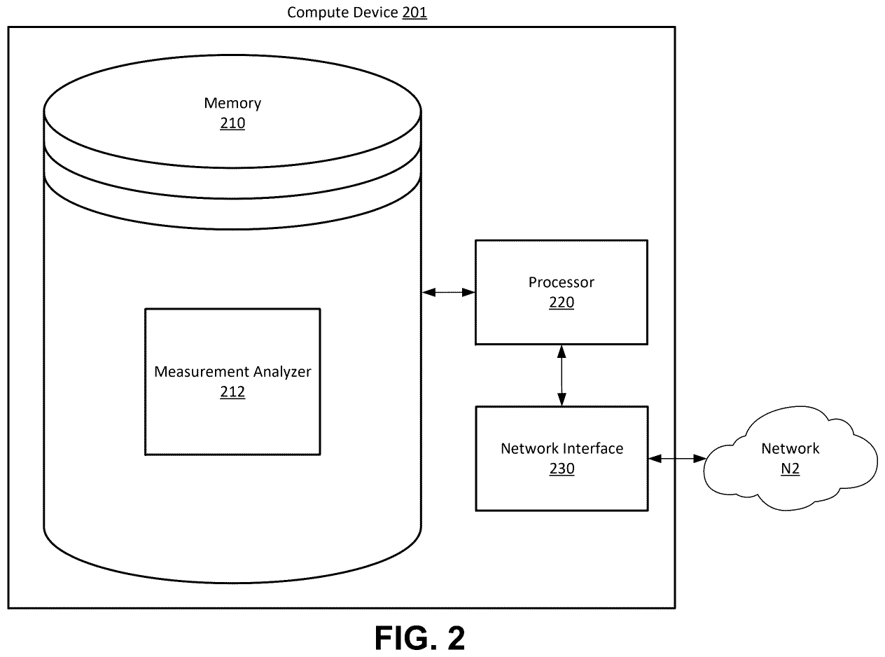

The compute device 110 can include a measurement analyzer 112, which can include software (1) stored at a memory that is functionally and/or structurally similar to the memory 210 of FIG. 2 discussed below and (2) executed via a processor that is functionally and/or structurally similar to the processor 220 of FIG. 2 discussed below. The measurement analyzer 112 can be configured to analyze measurement data (e.g., spectra data, microscopy data, image data, and/or etc.) produced by the measurement devices 140 (described herein) to, for example, identify a substance (e.g., fentanyl and/or etc.), a pathogen (e.g., an antibiotic-resistant pathogen and/or a foodborne pathogen), and/or other samples, as described herein. The measurement analyzer 112 can be functionally and/or structurally similar to the measurement analyzer 212 of FIG. 2. In some instances, the compute device 110 can be functionally and/or structurally similar to the compute device 310 of FIG. 3, such that the sample analysis apparatus 300 of FIG. 3 can perform at least some of the functions of the measurement analyzer 112, as described herein.

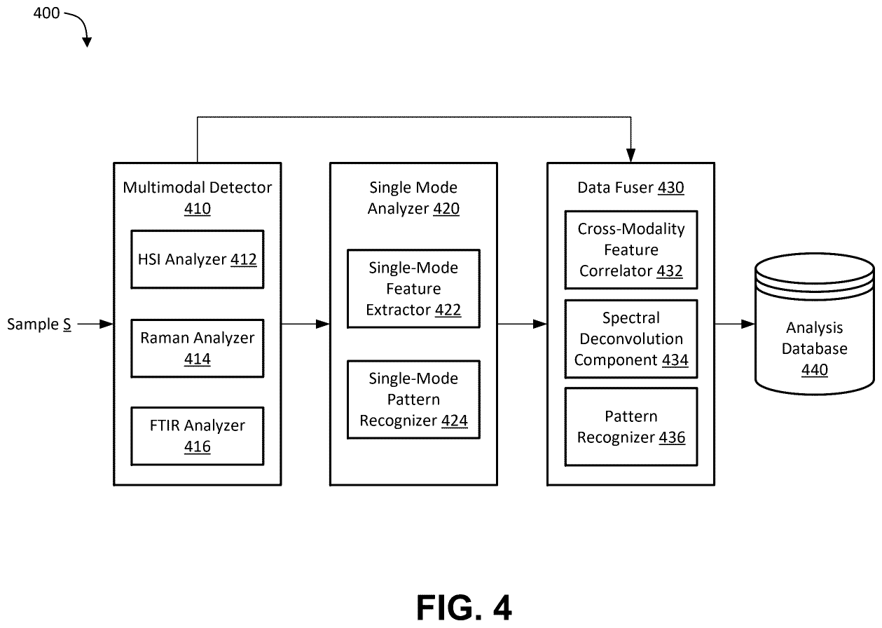

The compute device 120 can implement a user interface 122, which can include a programmatic interface (e.g., an application programming interface (API), a graphical user interface (GUI) (e.g., displayed on a monitor/display), and/or etc.) that is configured to receive input data (e.g., similar to the input data that represents the sample S of FIG. 4) from a user. The user interface 122 can further cause return and/or display of output data generated by the measurement analyzer 112 (e.g., based on persistent data produced by the measurement analyzer 112, as described herein). The user interface 122 can be implemented via software and/or hardware.

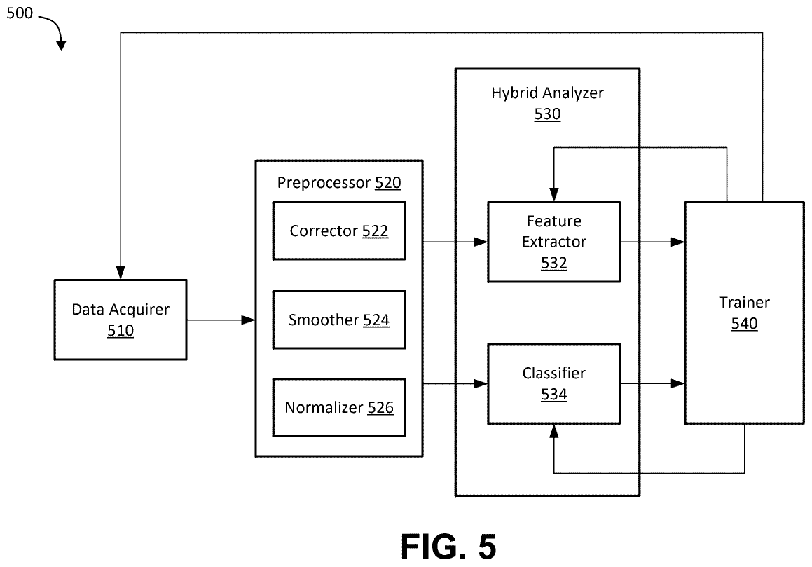

The remote compute device 130 can include a remote (e.g., as to the compute device 110 and/or the compute device 120) compute device(s) that can be configured to train, host, and/or execute a machine learning model 132. The machine learning model 132 can be functionally and/or structurally similar to the single-mode feature extractor 422 and/or the cross-modality feature correlator 432 of FIG. 4 and/or the feature extractor 532 and/or the classifier 534 of FIG. 5 (each described herein). The machine learning model 132 can include, for example, a feedforward neural network, a convolutional neural network, a support vector machine (SVM), a random forest, an autoencoder, and/or etc., as described further herein. In some implementations, the compute device 110 can execute a service (e.g., a prompt service) to provide input data to the machine learning model 132. Alternatively or in addition, although not shown in FIG. 1, the compute device 110 can train, host, and/or execute the machine learning model 132.

The measurement devices 140 can include modularized components that are configured to interface with a sample analysis apparatus (e.g., functionally and/or structurally similar to the sample analysis apparatus 300, 900, 1000, 1100, 1200, and/or 1300 described herein at least in relation to FIGS. 3, 9A-9B, 10, 11, 12, and 13, respectively). The measurement devices 140 can be configured collectively to perform multimodal measurements of a sample. For example, a first measurement device(s) from the measurement devices 140 can be configured to perform spectroscopy (e.g., Raman spectroscopy, Fourier transform infrared spectroscopy (FTIR), and/or etc.) and/or spectrometry, a second measurement device(s) can be configured to perform hyperspectral imaging (HSI), a third measurement device(s) can be configured to perform microscopy, a fourth measurement device(s) can be configured to perform red, green, blue (RGB) imaging, and/or the like, to produce measurement data, as described herein. A measurement device(s) from the measurement devices 140 can be functionally and/or structurally similar to the microscope 320, the multispectral imager 330, the Raman probe 340, the hyperspectral imager 350, and/or the RGB imager 360, each of FIG. 3 (described herein). Alternatively or in addition, at least some of the measurement devices 140 can, for example, be associated with the HSI analyzer 412, the Raman analyzer 414, and/or the FTIR analyzer 416 of FIG. 4, each described herein.

The analysis database 150 can store results (e.g., sample profile predictions) produced by the measurement analyzer 112 and/or the machine learning model 132. The analysis database 150 can be functionally and/or structurally similar to the analysis database 440 of FIG. 4, described herein.

The compute device 110 can be networked and/or communicatively coupled to the compute device 120, the remote compute device 130, the measurement devices 140, and/or the analysis database 150, via the network N1, using wired connections and/or wireless connections. The network N1 can include various configurations and protocols, including, for example, short range communication protocols, Bluetooth®, Bluetooth® LE, the Internet, World Wide Web, intranets, virtual private networks, wide area networks, local networks, private networks using communication protocols proprietary to one or more companies, Ethernet, WiFi® and/or Hypertext Transfer Protocol (HTTP), cellular data networks, satellite networks, free space optical networks and/or various combinations of the foregoing. Communication can be facilitated by any device capable of transmitting data to and from other compute devices, such as a modem(s) and/or a wireless interface(s).

In some implementations, although not shown in FIG. 1, the measurement analysis system 100 can include multiple compute devices 110, compute devices 120, and/or remote compute devices 130. For example, in some implementations, the measurement analysis system 100 can include multiple compute devices 110, where each compute device 110 can be associated with a different user from multiple users. In some implementations, multiple compute devices 110 can be associated with a single user, where each compute device 110 can be associated with, for example, a different input modality (e.g., text input, audio input, analog and/or digital signal input, image input, video input, etc.). Some implementations can include various combinations of the above.

FIG. 2 shows a system block diagram of a compute device 201 included in a measurement analysis system, according to an embodiment. The compute device 201 can be structurally and/or functionally similar to, for example, the compute device 110 of the measurement analysis system 100 shown in FIG. 1. The compute device 201 can be a hardware-based computing device, a multimedia device, or a cloud-based device such as, for example, a computer device, a server, a desktop compute device, a laptop, a smartphone, a tablet, a wearable device, a remote computing infrastructure, and/or the like. The compute device 201 includes a memory 210, a processor 220, and a network interface 230 operably coupled to a network N2.

The processor 220 can be, for example, a hardware-based integrated circuit (IC), or any other suitable processing device configured to run and/or execute a set of instructions or code (e.g., stored in memory 210). For example, the processor 220 can be a general-purpose processor, a central processing unit (CPU), an accelerated processing unit (APU), an application specific integrated circuit (ASIC), a field programmable gate array (FPGA), a programmable logic array (PLA), a complex programmable logic device (CPLD), a graphics processing unit (GPU), a programmable logic controller (PLC), a remote cluster of one or more processors associated with a cloud-based computing infrastructure and/or the like. The processor 220 is operatively coupled to the memory 210. In some implementations, for example, the processor 220 can be coupled to the memory 210 through a system bus (for example, address bus, data bus and/or control bus). In some implementations, the processor 220 can include multiple parallelly arranged processors.

The memory 210 can be, for example, a random-access memory (RAM), a memory buffer, a hard drive, a read-only memory (ROM), an erasable programmable read-only memory (EPROM), and/or the like. The memory 210 can store, for example, one or more software modules and/or code that can include instructions to cause the processor 220 to perform one or more processes, functions, and/or the like. In some implementations, the memory 210 can be a portable memory (e.g., a flash drive, a portable hard disk, and/or the like) that can be operatively coupled to the processor 220. In some instances, the memory can be remotely operatively coupled with the compute device 201, for example, via the network interface 230. For example, a remote database server can be operatively coupled to the compute device 201.

The memory 210 can store various instructions associated with processes, algorithms and/or data, as described herein. Memory 210 can further include any non-transitory computer-readable storage medium for storing data and/or software that is executable by processor 220, and/or any other medium, which may be used to store information that may be accessed by processor 220 to control the operation of the compute device 201. For example, the memory 210 can store data associated with a measurement analyzer 212. The measurement analyzer 212 can be configured to analyze measurement data (e.g., spectra data, microscopy data, image data, and/or etc.) produced by measurement devices (e.g., functionally and/or structurally similar to the measurement devices 140 of FIG. 1) to, for example, identify a substance (e.g., fentanyl and/or etc.), a pathogen (e.g., an antibiotic-resistant pathogen and/or a foodborne pathogen), and/or other samples, as described herein. The measurement analyzer 212 can be functionally and/or structurally similar to the measurement analyzer 112 of FIG. 1. In some instances, the compute device 201 can be functionally and/or structurally similar to the compute device 310 of FIG. 3, such that the sample analysis apparatus 300 of FIG. 3 can perform at least some of the functions of the measurement analyzer 212, as described herein.

The network interface 230 can be configured to connect to the network N2, which can be functionally and/or structurally similar to the network N1 of FIG. 1. For example, network N2 can use any of the communication protocols described above with respect to network N1 of FIG. 1. In some implementations, the network interface 230 can include a network interface controller (NIC) that implements a physical and/or data link layer (e.g., Ethernet, Wi-Fi®, etc.).

In some instances, the compute device 201 can further include a display, an input device, and/or an output interface (not shown in FIG. 2). The display can be any display device (e.g., a monitor, screen, etc.) by which the compute device 201 can output and/or display data (e.g., via a user interface that is structurally and/or functionally similar to the user interface 122 of FIG. 1). The input device can include, for example, a mouse, keyboard, touch screen, voice interface, and/or any other hand-held controller or device or interface via which a user may interact with the compute device 201. The output interface can include, for example, a bus, port, and/or other interfaces by which the compute device 201 may connect to and/or output data to other devices and/or peripherals.

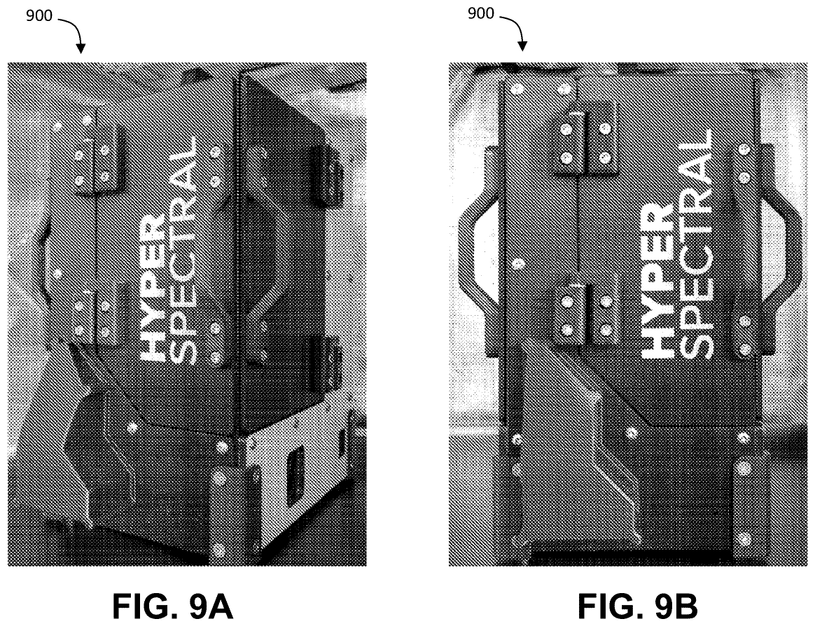

FIG. 3 shows a system block diagram of a sample analysis apparatus 300 included in a measurement analysis system, according to an embodiment. The sample analysis apparatus 300 can be functionally and/or structurally similar to the sample analysis apparatus 900, 1000, 1100, 1200, and/or 1300, described herein at least in relation to FIGS. 9A-9B, 10, 11, 12, and 13, respectively. The sample analysis apparatus 300 can be included in or otherwise associated with a measurement analysis system that is functionally and/or structurally similar to the measurement analysis system 100 of FIG. 1. For example, in some implementations, the sample analysis apparatus 300 can include a compute device 310 that is functionally and/or structurally similar to the compute device 110 of FIG. 1 and/or the compute device 201 of FIG. 2. In some implementations, this compute device 310 can include components that are functionally and/or structurally similar to the multimodal analysis components 400 of FIG. 4 and/or the hybrid analysis components 500 of FIG. 5.

The sample analysis apparatus 300 includes a compute device 310, an actuator(s) 370, a sample surface 380, and a network interface 390. Optionally (as shown by dashed lines in FIG. 3), the sample analysis apparatus 300 can include at least one of a microscope 320, a multispectral imager 330, a Raman probe 340, a hyperspectral imager 350, and/or a RGB imager 360, at least some of which can be added to, removed from, and/or swapped, in modularized fashion. The solid line between the actuator(s) 370 and the sample surface 380 can indicate a mechanical connection and/or contact, and the dotted lines from the compute device 310 and/or the network interface 390 can indicate electrical connections, signal/communication connections, signal/communication pathways (e.g., wireless signal paths), and/or the like.

The compute device 310 can be functionally and/or structurally similar to the compute device 110 of FIG. 1 and/or the compute device 201 of FIG. 2. In some implementations, the compute device 310 can implement the HSI analyzer 412, the Raman analyzer 414, and/or the FTIR analyzer 416 of FIG. 4, each described herein, where the hyperspectral imager 350 can be associated with the HSI analyzer 412, the Raman probe 340 can be associated the Raman analyzer 414, and the multispectral imager 330 can be associated with the FTIR analyzer 416. Although not shown in FIG. 4 (described further herein), the compute device 310 can implement other analyzers associated with the microscope 320, the multispectral imager 330 (e.g., analyzers for bands other than or in addition to FTIR), and/or the RGB imager 360.

At least some of the microscope 320, the multispectral imager 330, the Raman probe 340, the hyperspectral imager 350, and/or the RGB imager 360 can be functionally and/or structurally similar to at least some of the measurement devices 140 of FIG. 1. In some implementations, the microscope 320 can include, for example, a transmission electron microscope, a scanning electron microscope, an optical microscope, a compound microscope, and/or the like. In some implementations, the multispectral imager 330 can be configured to perform at least one of ultraviolet-visible (UV-Vis) spectroscopy, fluorescence spectroscopy, infrared (IR) spectroscopy, Fourier transform infrared (FTIR) spectroscopy, near-infrared (NIR) spectroscopy, mid-infrared (MIR) spectroscopy, far-infrared (FIR) spectroscopy, x-ray spectroscopy, and/or the like. In some implementations, the Raman probe 340 can be configured to perform Raman spectroscopy, surface-enhanced Raman spectroscopy, waveguide-enhanced Raman spectroscopy, and/or the like. In some implementations, the hyperspectral imager 350 can be configured to perform at least one of spatial scanning, spectral scanning, non-scanning/snapshot imaging, and/or spatiospectral scanning. The RGB imager 360 can include an RGB camera. Alternatively or in addition, the sample analysis apparatus 300 can include a camera associated with another color scale, such as greyscale and/or etc.

The compute device 310 can receive measurement data from the microscope 320, the multispectral imager 330, the Raman probe 340, the hyperspectral imager 350, and/or the RGB imager 360, each of which can be oriented to capture a sample disposed on (or near) the sample surface 380. The compute device 310 can the process this measurement data to identify and/or otherwise characterize the sample, as described further herein at least in relations to FIGS. 4 and 5.

The compute device 310 can further implement and/or include a controller (e.g., a microcontroller, a software program, and/or etc.) that is configured to send control signals to the actuator(s) 370 to cause the actuator(s) 370 to actuate/move the sample surface 380. For example, in some implementations, the actuator(s) can include an X-Y table (which can include, for example, an X-axis-oriented linear actuator and a Y-axis-oriented linear actuator) and/or a Z-axis-oriented (e.g., vertically-oriented) linear actuator. The compute device 310 can receive positional data for a sample resting on (or otherwise disposed at) the sample surface 380. This positional data can be captured via, for example, the RGB imager 360 and/or the like. Using this positional data for feedback control, the compute device 310 can cause the actuator(s) 370 to position the sample surface 380 such that the sample is within the field of view(s) and/or at a focal point(s) of at least one of the microscope 320, the multispectral imager 330, the Raman probe 340, the hyperspectral imager 350, and/or the RGB imager 360. The sample surface 380 can include, for example, a sample tray, a slide, a well, and/or the like.

In some implementations, the compute device 310 can detect which modularized components (e.g., the microscope 320, the multispectral imager 330, the Raman probe 340, the hyperspectral imager 350, and/or the RGB imager 360) are coupled to/plugged into the sample analysis apparatus 300, and/or at which slots/bays of the sample analysis apparatus 300. The compute device 310 can then modify feedback control of the actuator(s) 370, through control signals, accordingly, such that the sample is appropriately disposed relative to the active modularized components. By detecting slot activations instead of, for example, using the modularized components themselves to detect sample positioning, the compute device 310 can conserve compute resource usage (e.g., processor usage, memory usage, bandwidth usage, and/or etc.) that might otherwise be used for image processing, machine vision, and/or other operations that sample detection might otherwise involve.

The network interface 390 can be functionally and/or structurally similar to the network interface 230 of FIG. 2. The network interface 390 can be configured to connect to the network N3, which can be functionally and/or structurally similar to the network N1 of FIG. 1 and/or the network N2 of FIG. 2. The network interface 390 can permit the compute device 310 to, for example, access a machine learning model(s) (e.g., functionally and/or structurally similar to the machine learning model 132 of FIG. 1) hosted at a remote compute device (e.g., the remote compute device 130 of FIG. 1), as described herein. Alternatively or in addition, the network interface 390 can permit the compute device 310 to store data at a database (e.g., functionally and/or structurally similar to the analysis database 150 of FIG. 1), as described herein.

FIG. 4 shows a system block diagram of multimodal analysis components 400 included in a measurement analysis system, according to an embodiment. At least a portion of the multimodal analysis components 400 can be associated with a compute device (e.g., a compute device that is structurally and/or functionally similar to the compute device 310 of FIG. 3, the compute device 201 of FIG. 2, and/or the compute devices 110 and 120 of FIG. 1). For example, the multimodal analysis components 400 can include, be included in, implement, and/or be associated with (1) the measurement analyzer 112 of FIG. 1 and/or (2) the measurement analyzer 212 of FIG. 2. In some instances, the multimodal analysis components 400 can include software stored in memory 210 and configured to execute via the processor 220 of FIG. 2. In some instances, at least a portion of the multimodal analysis components 400 can be implemented in hardware (e.g., an ASIC) or a combination of hardware (e.g., a general-purpose processor) and software.

The multimodal analysis components 400 receive a sample S (and/or data that represents the sample S) and include and/or have access to a multimodal detector 410, a single-mode analyzer 420, a data fuser 430, and an analysis database 440 (e.g., functionally and/or structurally similar to the analysis database 150 of FIG. 1). The multimodal detector 410 includes a hyperspectral imaging (HSI) analyzer 412, a Raman analyzer 414, and a Fourier transform infrared spectroscopy (FTIR) analyzer 416. The single-mode analyzer 420 includes a single-mode feature extractor 422 and a single-mode pattern recognizer 424. The data fuser 430 includes a cross-modality feature correlator 432, a spectral deconvolution component 434, and a pattern recognizer 436.

The sample S can include, for example, a raw sample of a drug (e.g., fentanyl), a pathogen, and/or another substance, material, microorganism, and/or the like to be profiled. The sample S can undergo parallel analysis via the components of the multimodal detector 410 (e.g., the HSI analyzer 412, the Raman analyzer 414, and/or the FTIR analyzer 416). At a high level, each component of the multimodal detector 410 can be configured to perform spectroscopy at different wavelengths, frequencies, energies, and/or etc. As a result, the multimodal detector 410 can produce data that represents a plurality of spectrums. More specifically, as described further herein for each component, the HSI analyzer 412 can perform miniaturized hyperspectral imaging to capture spatial chemical distribution within the sample S (e.g., to capture fentanyl and/or cutting agents) in near-microscopic detail. The Raman analyzer 414 can provide molecular-level fingerprinting of the sample S (e.g., fingerprinting of fentanyl analogs and/or precursor chemicals). The FTIR analyzer 416 can pinpoint functional groups and/or polar bonds to, for example, reveal unique synthetic routes.

In some implementations, although not shown in FIG. 4, the multimodal detector 410 can be associated with modalities other than HSI, Raman, and FTIR. For example, in some implementations, the multimodal detector 410 can include a component/device that is functionally and/or structurally similar to at least one of the microscope 320, the multispectral imager 330, the Raman probe 340, the hyperspectral imager 350, and/or the RGB imager 360, each of FIG. 3.

Turning to the HSI analyzer 412 in further detail, this component can provide spatial distribution mapping of chemical components across the surface (e.g., the entire surface) of the sample S. The HSI analyzer 412 can therefore detect heterogeneous mixing patterns that are characteristic of, for example, specific drug manufacturing processes. In some implementations, the HSI analyzer 412 can perform HSI to identify subtle variations in chemical composition that can indicate different synthetic routes and/or production batches. Additionally, HSI's non-destructive nature can preserve evidence for further forensic analysis while providing rapid initial screening. By capturing spectral bands (e.g., hundreds of spectral bands) simultaneously, concurrently, and/or contemporaneously, the HSI analyzer 412 can facilitate detection of, for example, trace compounds and/or cutting agents that can otherwise be missed by some known single-point analysis methods.

An example wavelength in the range of, for example, 400-1700 nm (e.g., a continuous wavelength band having steps of, for example, 1 nm) can be associated with HSI performed by the HSI analyzer 412. In some implementations, the HSI analyzer 412 can produce a hyperspectral image (represented by hyperspectral image data) that represents a wavelength spectrum for each pixel from a plurality of pixels of the hyperspectral image. In some implementations, the HSI analyzer 412 can be performed by an HSI device that employs micro-electro-mechanical systems (MEMS) based miniaturization (e.g., by integrating optical components like micromirrors and/or scanners onto silicon chips) to cause the HSI device to have a smaller (e.g., 40% smaller than a non-MEMS HSI device) and more portable form factor.

Turning now to the Raman analyzer 414, this component can be configured to perform and/or analyze data from Raman spectroscopy, which can include a label-free, non-destructive technique based on inelastic scattering of monochromatic light. The Raman analyzer 414 can perform molecular fingerprinting of the sample S and/or analogs of the sample S. Raman spectroscopy's ability to detect specific molecular vibrations can permit the Raman analyzer 414 to provide definitive identification of chemical structures to distinguish between similar derivatives (e.g., fentanyl derivatives). In some implementations, Raman spectroscopy's high specificity can also allow for detection of subtle molecular differences that separate, for example, legal pharmaceutical compounds from illicit variants. Raman spectroscopy's capability to analyze samples through transparent packaging materials (like plastic bags and/or glass vials) can be particularly useful for rapid field testing while maintaining evidence integrity. Alternatively or in addition, Raman spectroscopy's sensitivity to crystal structure can provide insights into drug manufacturing processes, as different crystallization methods can produce distinct Raman signatures.

An example excitation wavelength of 785 nm and/or an example resolution of 4 cm⁻¹ can be associated with Raman spectroscopy performed by the Raman analyzer 414. By optimizing (or improving) wavelength selection, the Raman analyzer 414 can facilitate a reduction (e.g., a 3× reduction) in fluorescence interference.

The FTIR analyzer 416 can be configured to provide molecular structure information that is complimentary to and determined through different physical principles than information determined by the HSI analyzer 412 and/or the Raman analyzer 414. The FTIR analyzer 416 can be configured to perform FTIR to identify functional groups. In some instances, FTIR can be particularly sensitive to polar bonds and can therefore be suitable in at least some instances for detecting, for example, cutting agents and/or synthetic precursors used in the production of, for example, fentanyl and/or the like. In at least some instances, the FTIR analyzer 416 can use FTIR to analyze both organic and inorganic compounds to create a complete chemical profile (e.g., chemical composition) of the sample S. FTIR's high sensitivity to hydrogen bonding patterns can also reveal information about purity and/or crystallinity of the sample S, which can be linked to specific manufacturing processes. Additionally, spectral libraries associated with FTIR can enable rapid comparison with, for example, known fentanyl variants and common adulterants.

The FTIR analyzer 416 can be associated with a spectral range of, for example, about 400-4000 cm⁻¹ and/or can have an example resolution of about 4 cm⁻¹. In some instances, the FTIR analyzer 416 can be configured to perform pressure-free ATR sampling. In some implementations, the FTIR analyzer 416 can analyze the sample S without prior preparation of the sample S.

By receiving sets of measurement (e.g., spectrum) data from, respectively, the HSI analyzer 412, the Raman analyzer 414, and the FTIR analyzer 416, the multimodal detector 410 can facilitate a synergistic effect that can overcome at least some limitations of at least some of the individual components of the multimodal detector 410. More specifically, the multimodal detector 410 can promote cross-validation as a result of each component providing confirmation of chemical identification, reducing false positives and reducing false negatives. In some implementations, the multimodal detector 410 can be configured to perform adaptive analysis by emphasizing data from the most appropriate component based on sample characteristics (e.g., using data from the FTIR analyzer 416 for highly fluorescent samples that might challenge the Raman analyzer 414). In some implementations, the multimodal detector 410 can produce complementary information. For example, the HSI analyzer 412 can be configured to produce spatial distribution data, the Raman analyzer 414 can be configured to determine molecular fingerprinting, and the FTIR analyzer 416 can produce functional group information. As a result, these components can collectively produce a comprehensive chemical profile. In some instances, the combined data produced by the multimodal detector 410 can further provide insights into synthesis routes, cutting agents, production methods, and/or the like, associated with the sample S.

Turning to the single-mode analyzer 420, this component can be configured to separately analyze individual spectra (each represented by a set of spectrum data) produced by the HSI analyzer 412, the Raman Analyzer 414, and/or the FTIR analyzer 416. For example, the single-mode feature extractor 422 can include a convolutional neural network (CNN), a recurrent neural network (RNN), and/or another single-mode machine learning model, configured to classify the spectrum data to identify a single-mode feature(s) (e.g., a classification of a type associated with the sample S, a classification of a characteristic of the sample S, and/or etc., as represented by the given spectrum). The single-mode pattern recognizer 424 can be configured to reference predefined patterns to identify the patterns in a spectrum. For example, for an HSI spectrum, the single-mode pattern recognizer 424 can detect heterogeneous mixing patterns characteristic of specific drug manufacturing processes and/or identify subtle variations in chemical composition that may indicate different synthetic routes or production batches. For an FTIR spectrum (represented by FTIR spectrum data), the single-mode pattern recognizer 424 can identify hydrogen bonding patterns that indicate drug purity and/or crystallinity, which can be linked to specific manufacturing processes.

After the single-mode analyzer 420 classifies spectra individually, the data fuser 430 can classify the spectra collectively and/or concurrently. More specifically, the cross-modality feature correlator 432 can include a feed-forward neural network and/or the like and a spectral adaptation layer that implements a specialized (e.g., as to spectral analysis) attention mechanism. Collectively, the feed-forward network and the spectral adaptation layer can implement a multimodal fusion network that performs cross-attention (e.g., via a cross-attention layer) between different modalities (e.g., between different spectra produced by the multimodal detector 410). The cross-modality feature correlator 432 can perform this cross-attention by progressively reducing dimensionality (d) of the spectra [e.g., 2d, d, d/2], effectively distilling the cross-modal information represented by the spectra into a compact (e.g., memory efficient) yet informative representation (e.g., a vector representation or other embedded representation).

Examples of features determined by the cross-modality feature correlator 432 include, for example, chemical markers and/or physical characteristics of the sample S. In some implementations, the cross-modality feature correlator 432 can be configured to perform comprehensive source attribution through detailed analysis of the chemical markers and/or physical characteristics. Chemical marker analysis can involve examining synthesis route indicators, cutting agent signatures, trace element profiles, and/or isotopic ratios. Physical characteristics assessment can include crystal morphology analysis, tablet pressing patterns, microscopic surface features, and/or packaging material analysis. These combined capabilities can permit the cross-modality feature correlator 432 to identify and track the origins of the sample S.

Turning to other components of the data fuser 430, the spectral deconvolution component 434 can be configured to identify trace adulterants and/or precursors associated with the sample S. More specifically, in some implementations, the spectral deconvolution component 434 can receive spectral data from the multimodal detector 410 (e.g., from one or more of the HSI analyzer 412, the Raman analyzer 414, and/or the FTIR analyzer 416). In some implementations, although not shown in FIG. 4, the spectral deconvolution component 434 can resolve spectral data (as described below) before providing the resulting resolved spectral data to the single-mode analyzer 420.

In use, the spectral deconvolution component 434 can separate signals that are associated with a primary substance and the adulterants/precursor and that have been mixed (convolved) in the physical domain (e.g., as a result of multiple compounds eluting together, light blurring, and/or etc.). More specifically, the spectral deconvolution component 434 can generate a model of ideal and/or separate peaks (e.g., Gaussian and/or Lorentzian shapes) based on the spectra from the multimodal detector 410. The spectral deconvolution component 434 can mathematically convolve (blur/combine) the model (to produce a convoluted model) based on the predetermined response for a given of the spectrometer(s) (e.g., point spread function and/or impulse response associated with the spectrometer(s)) that captured the spectra (e.g., via the multimodal detector 410). The spectral deconvolution component 434 can then adjust the parameters (e.g., position, height, width) of the model peaks until the simulated, convoluted spectrum matches (e.g., within a predefined threshold) a raw, observed, and distorted spectra from the multimodal detector 410. The final parameters of the adjusted model peaks can represent the centers, intensities, and shapes of the original, unblurred components.

The pattern recognizer 436 can be configured to reference predefined patterns to identify the patterns in the collective spectra to, for example, identify chemical signatures tied to specific manufacturing routes and/or perform batch differentiation.

FIG. 5 shows a system block diagram of hybrid analysis components 500 included in a measurement analysis system, according to an embodiment. At least a portion of the hybrid analysis components 500 can be associated with a compute device (e.g., a compute device that is structurally and/or functionally similar to the compute device 310 of FIG. 3, the compute device 201 of FIG. 2, and/or the compute devices 110 and 120 of FIG. 1). For example, the hybrid analysis components 500 can include, be included in, implement, and/or be associated with (1) the measurement analyzer 112 of FIG. 1 and/or (2) the measurement analyzer 212 of FIG. 2. In some instances, the hybrid analysis components 500 can include software stored in memory 210 and configured to execute via the processor 220 of FIG. 2. In some instances, at least a portion of the hybrid analysis components 500 can be implemented in hardware (e.g., an ASIC) or a combination of hardware (e.g., a general-purpose processor) and software.

The hybrid analysis components 500 include a data acquirer 510, a preprocessor 520, a hybrid analyzer 530, and a trainer 540. The preprocessor 520 includes a corrector 522, a smoother 524, and a normalizer 526. The hybrid analyzer 530 includes a feature extractor 532 and a classifier 534.

In some implementations, the hybrid analysis components 500 can be used to analyze a sample that has been prepared by, for example, culturing target pathogens under standardized conditions (e.g., on agar or in broth) to minimize biological variability. Cells can then be washed and placed onto gold-coated slides to reduce extraneous fluorescence and ensure consistent surface interactions for Raman measurements. A 785 nm laser with a Raman spectrometer (e.g., a Wasatch Photonics (WP-785X-F13-R-ILC-785nm 10C regulated Raman spectrometer) can be used with, for example, ~8 cm⁻¹ spectral resolution. This spectrometer can be functionally and/or structurally similar to the measurement devices 140 of FIG. 1. Each pathogen isolate can be sampled, for example, 10 or more times to capture within-strain heterogeneity.

The data acquirer 510 can be configured to acquire raw spectra data generated by the Raman spectrometer. This raw spectra data can include, for example, fluorescence backgrounds, shot noise, and/or baseline drift. The preprocessor 520 can therefore apply to the raw spectra data at least one of a baseline correction (e.g., using polynomial and/or rolling-circle methods via the corrector 522, to result in corrected spectrum data), noise smoothing (e.g., Savitzky-Golay filtering via the smoother 524, to result in smoothed spectrum data), and/or normalization (e.g., vector and/or total-area normalization via the normalizer 526, to result in normalized spectrum data), to ensure that downstream analyses focus on relevant biochemical peaks rather than instrumentation artifacts.

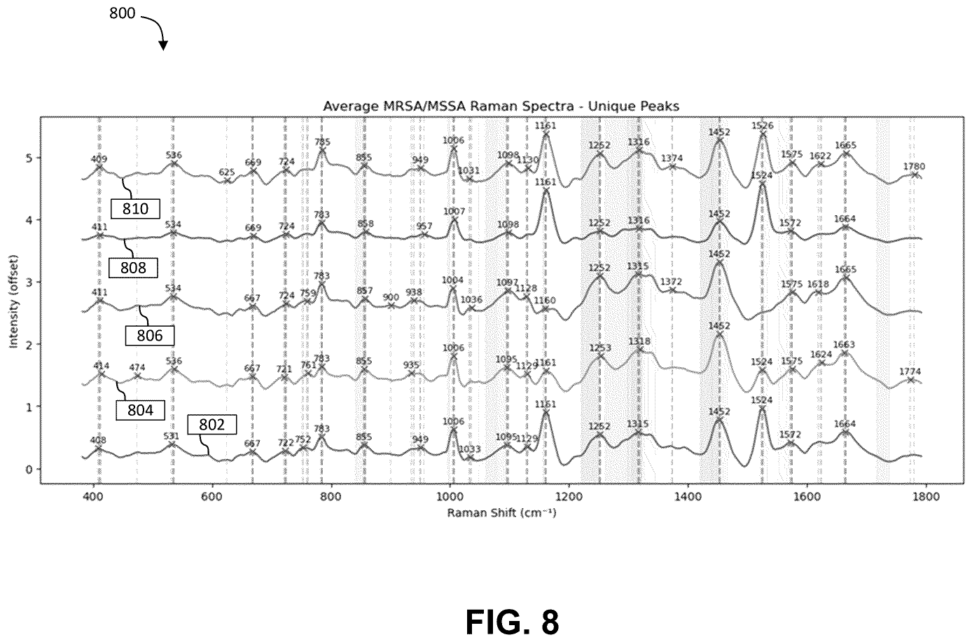

Following the data preprocessing, the hybrid analyzer 530 can apply a hybrid approach that combines feature extraction (via the feature extractor 532) and classification (via the classifier 534). The feature extractor 532 can be configured to perform principal component analysis (PCA) to reduce dimensionality of the preprocessed spectra data and highlight/amplify dominant spectral variations across multiple samples (e.g., resulting in dominant spectral variation data, described further herein at least in relation to FIG. 8). The feature extractor 532 can then use autoencoder networks (e.g., having convolutional layers) to capture subtle, non-linear features that the PCA might have missed. The autoencoders can compress spectra into a lower dimensional latent space (e.g., to result in embedded data), mitigating noise and improving classification robustness.

The classifier 534 can include (or have access to) a convolutional neural network (CNN) configured to learn local spectral signatures. More specifically, the classifier 534 can use convolutional kernels to capture peak shifts in the vibrational fingerprint region, building hierarchical feature representations. In some implementations, classifier 534 can include (or have access to) (1) a support vector machine (SVM) with a radial basis function (RBF) kernel and/or (2) a Random Forest (RF) (e.g., with 100-200 trees), which can improve detection when combined with features from PCA and/or autoencoder-derived embeddings.

Turning to the trainer 540, to ensure statistically sound results and guard against overfitting, particularly in smaller or highly imbalanced datasets, the trainer 540 can be configured to perform k-fold cross-validation (e.g., where k=5, 10, etc.). In each fold, the trainer 540 can split input data (e.g., measurement data, spectra data, and/or the like) into training and validation/test sets, cycling through all data so that every sample eventually appears in a test set. For example, as shown in FIG. 5, the trainer 540 can cause the data acquirer 510 to provide a subset of raw measurement/spectra data to the preprocessor 520, such that a subset of preprocessed measurement/spectra data can be provided to the hybrid analyzer 530 for either training or validation. During training of the feature extractor 532 and/or the classifier 534, the trainer 540 can finetune hyperparameters (e.g., learning rates, regularization terms, kernel parameters for SVM, tree counts for RF, and/or etc.) based on outputs from the hybrid analyzer 530, using, for example, grid and/or random search. The trainer 540 can be further configured to examine stopping criteria based on validation loss to prevent or reduce overfitting.

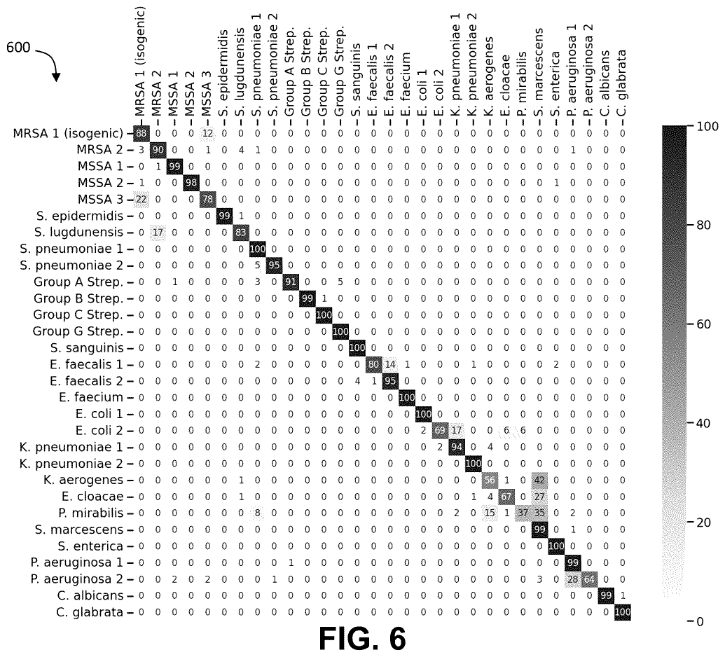

FIG. 6 shows a confusion matrix 600 that represents performance of a machine learning model(s) associated with a measurement analysis system, according to an embodiment. The machine learning model(s) can be associated with (e.g., accessible by), for example, the feature extractor 532 and/or the classifier 534 of FIG. 5. The confusion matrix 600 can represent, for example, a panel of 30 diverse bacterial species (e.g., having 50-100 replicates per species, totaling 2,000 samples across the 30 classes to capture the natural biological variability). The Raman spectra represented by the confusion matrix 600 can have undergone at least one of baseline correction, smoothing, and/or normalization before being passed to the machine learning model(s), as described herein.

The confusion matrix 600 shows that the majority of errors (e.g., detection/classification errors) produced by the machine learning model(s) were isolated to closely related taxa that share similar biochemical compositions (e.g., minor misclassifications within Enterobacteriaceae). In contrast, more phylogenetically distant species were nearly always correctly identified. This performance underscores the usefulness of deep-feature extraction in capturing subtle vibrational signatures in Raman spectra. Moreover, these results highlight the capability of at least some systems and methods described herein to build a broad-spectrum database, encompassing multiple genera and species, so that new or emerging pathogens can be classified rapidly if their spectra fall within known distribution patterns.

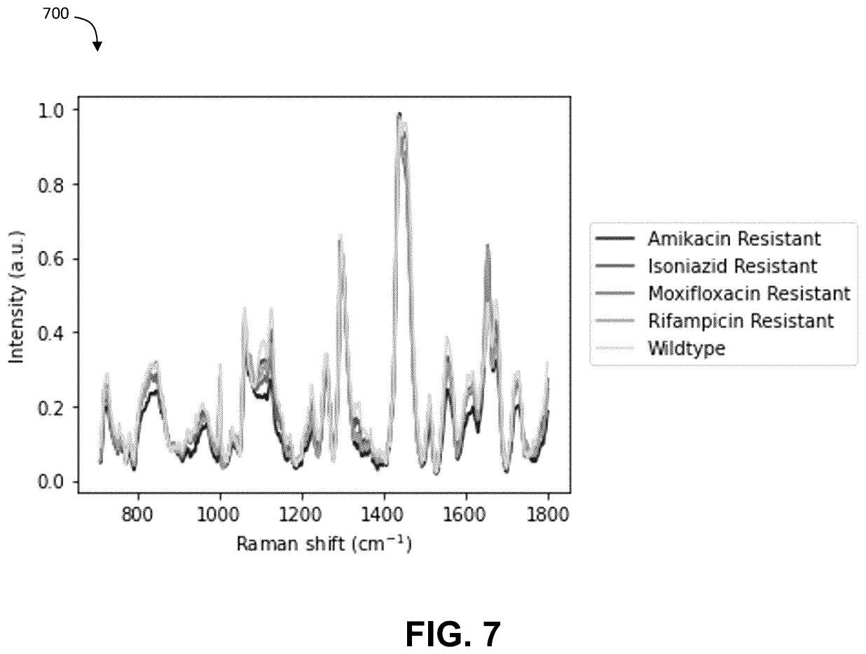

FIG. 7 shows a representation 700 of strains of antibiotic-resistant tuberculosis bacteria (e.g., Mycobacterium tuberculosis) analyzed by a measurement analysis system, according to an embodiment. Classifying multidrug-resistant (MDR) vs. drug-sensitive strains of Tuberculosis can be difficult using some known methods due to the complex cell wall of Mycobacterium tuberculosis, characterized by high lipid content and mycolic acids, which can make rapid phenotypic detection challenging.

The dataset represented in FIG. 7 includes five different strains/classes of Tuberculosis resistant to different antibiotics. Each class includes 1702 samples and were scanned on a spectrometer (e.g., a Horiba® spectrometer) with a laser activation at 633 nm and laser power of 13.17 mW. FIG. 7 shows more specifically the background corrected spectral data of each class. Additionally, the representation 700 illustrates clinical samples the same 5 classes of antibiotic-resistant Tuberculosis from mucus samples derived from clinic settings, modeled by at least some systems and methods described herein. This dataset includes 2952 samples scanned with a laser activation of 785 nm at 2.53 mW. The models were trained using 10 random holdout cross validation sets with 70% training, 10% validation, and 20% test set split. Final accuracy was found by averaging the test set accuracy of all 10 models. Lab samples model performance had an accuracy of 99.8%, and clinical samples model performance had an accuracy of 90.5%.

To evaluate the efficacy in an industrial context of at least some systems and methods described herein, the detection of Listeria monocytogenes, Escherichia coli, and Salmonella enterica in lab and environmental swab samples can be used. Results show that these pathogens were consistently identified with approximately 95% accuracy, and the total time to achieve result spanning sample preparation, spectral acquisition, and classification—was substantially shorter than some known techniques, such as some known culture-based methods, which typically span 24-48 hours or longer for bacterial growth and confirmation.

In practical terms, these findings illustrate the potential for Raman-AI systems such as those described herein to serve as near-real-time screening tools on production lines, allowing for rapid intervention if contamination is detected. The high sensitivity (recall) observed is particularly pivotal for food safety, given that missing even a single contaminated sample can have significant public health ramifications. Together, these results underscore the versatility of the Raman-AI pipeline in addressing both clinical and food-safety challenges through fast, accurate, and label-free bacterial identification.

FIG. 8 shows a graph 800 of Raman spectral profiles (e.g., average Raman spectral profiles) for five strains of Staphylococcus aureus, according to an embodiment. The five strains include two methicillin-resistant Staphylococcus aureus strains (MRSA), represented in graph 800 by profiles 802 and 804, and three methicillin-susceptible Staphylococcus aureus strains (MSSA), represented in graph 800 by profiles 806, 808, and 810. The profiles 802-810 of the graph 800 can represent dominant spectral variations (e.g., that are amplified by a feature extractor that is functionally and/or structurally similar to the feature extractor 532 of FIG. 5). For example, a dominant spectral variation can be represented by a peak, peak shift, peak to peak ratio, peak to trough ratio, 1^{st} derivative, and/or 2nd derivative, of a signal waveform associated with a profile 802-810. A dominant spectral variation can improve classification performed by a classifier that is functionally and/or structurally similar to the classifier 534 of FIG. 5.

More specifically, for example, the graph 800 can illustrate that methicillin resistant strains of Staphylococcus aureus show higher intensities (an example of a dominant spectral variation) at ~1290 cm⁻¹ as compared to methicillin susceptible strains, due to differences in amide III proteins. Graph 800 further illustrates carbon-hydrogen (CH) deformation profiles (a further example of a dominant spectral variation) in the 1300-1350 cm⁻¹ range.

FIGS. 9A-9B show views of a sample analysis apparatus 900 in a storage/transport configuration, the apparatus included in measurement analysis system, according to an embodiment. The sample analysis apparatus 900 can be functionally and/or structurally similar to the sample analysis apparatus 300, 1000, 1100, 1200, and/or 1300, described herein at least in relation to FIGS. 3, 10, 11, 12, and 13, respectively. The sample analysis apparatus 900 can be included in or otherwise associated with a measurement analysis system that is functionally and/or structurally similar to the measurement analysis system 100 of FIG. 1. For example, in some implementations, the sample analysis apparatus 900 can include a compute device that is functionally and/or structurally similar to the compute device 110 of FIG. 1 and/or the compute device 201 of FIG. 2. In some implementations, this compute device can include components that are functionally and/or structurally similar to the multimodal analysis components 400 of FIG. 4 and/or the hybrid analysis components 500 of FIG. 5.

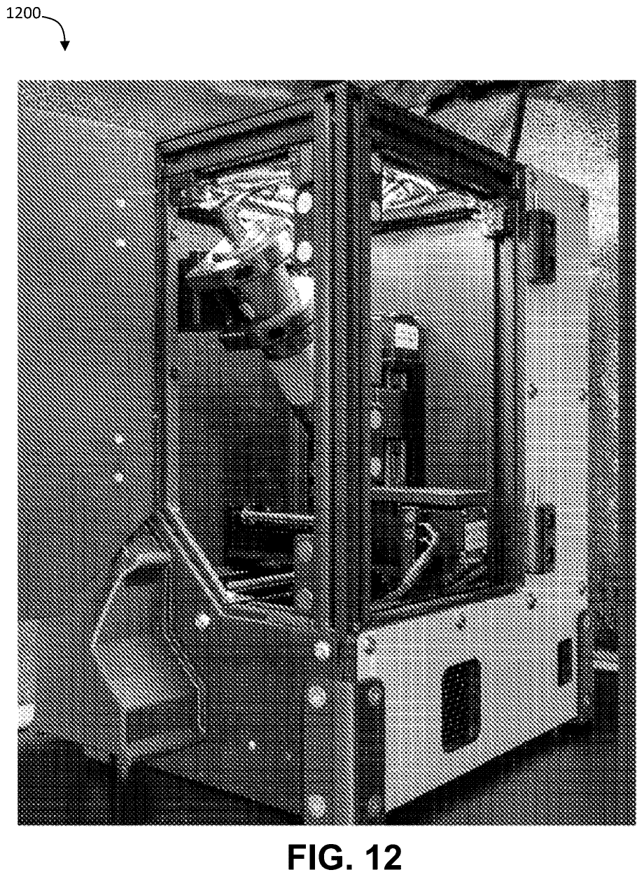

In some implementations, the sample analysis apparatus 900 can include at least one hinged (or otherwise attached) door (e.g., two hinged doors that orthogonal to each other, as shown in FIG. 9A-9B). When closed (e.g., when the sample analysis apparatus 900 is in a storage/transport configuration), the hinged door(s) can cover a viewing/access window, an example of which is shown in FIG. 12 (described herein).

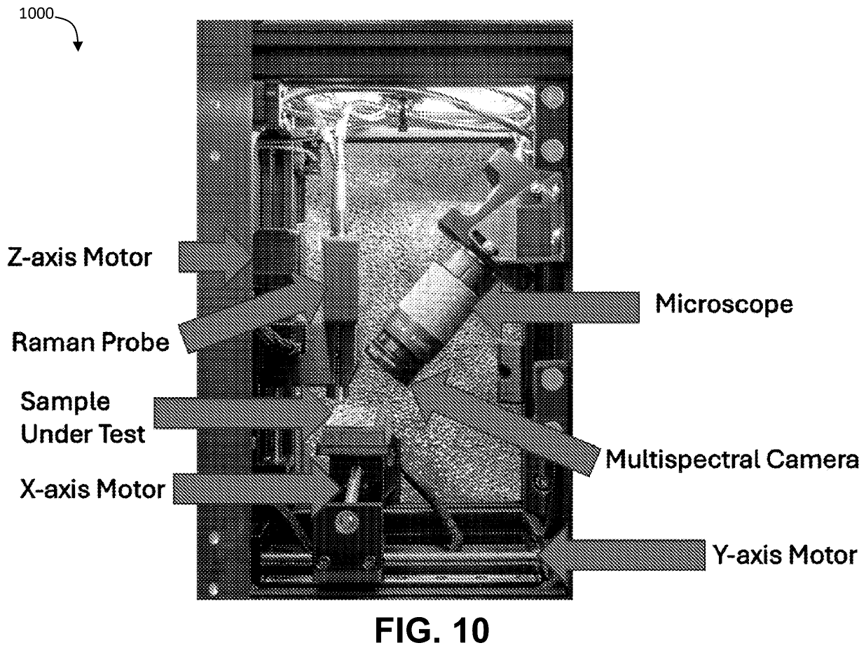

FIG. 10 shows a cutaway view of a sample analysis apparatus 1000 included in a measurement analysis system, according to an embodiment. As shown in FIG. 10, the sample analysis apparatus 1000 is configured to include/house a Raman spectroscopy component (referred to in FIG. 10 as a Raman probe), a microscopy component (e.g., a microscope), and a multispectral imaging component (e.g., a multispectral camera). The sample analysis apparatus 1000 can be functionally and/or structurally similar to the sample analysis apparatus 300, 900, 1100, 1200, and/or 1300, described herein at least in relation to FIGS. 3, 9A-9B, 11, 12, and 13, respectively. The sample analysis apparatus 1000 can be included in or otherwise associated with a measurement analysis system that is functionally and/or structurally similar to the measurement analysis system 100 of FIG. 1. For example, in some implementations, the sample analysis apparatus 1000 can include a compute device that is functionally and/or structurally similar to the compute device 110 of FIG. 1 and/or the compute device 201 of FIG. 2. In some implementations, this compute device can include components that are functionally and/or structurally similar to the multimodal analysis components 400 of FIG. 4 and/or the hybrid analysis components 500 of FIG. 5. In some implementations, the sample analysis apparatus 1000 can be configured to accept/interface with at least one modularized component, which can be functionally and/or structurally similar to, for example, the microscope 320, the multispectral imager 330, the Raman probe 340, the hyperspectral imager 350, and/or the RGB imager 360, each of FIG. 3.

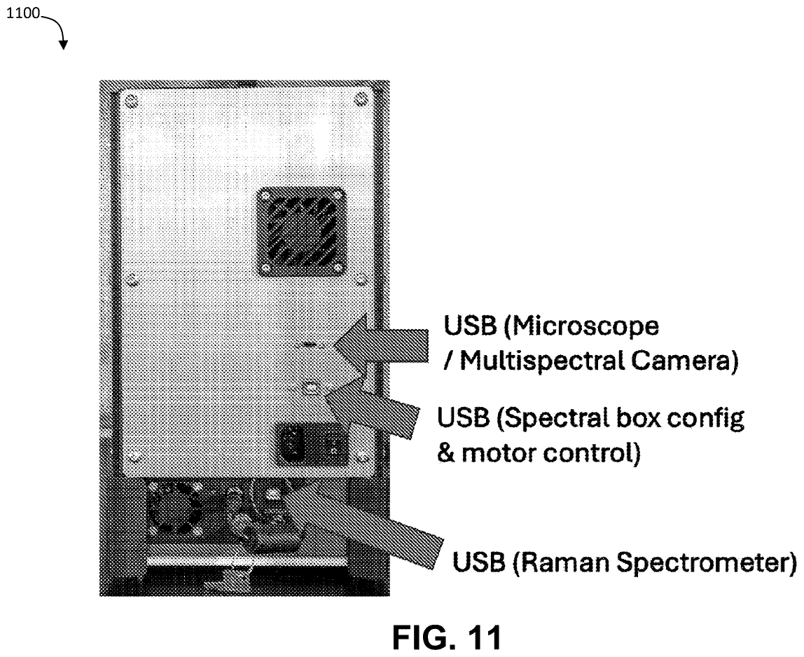

FIG. 11 shows a view of interfaces of a sample analysis apparatus 1100 that is included in a measurement analysis system, according to an embodiment. The sample analysis apparatus 1100 can be functionally and/or structurally similar to the sample analysis apparatus 300, 900, 1000, 1200, and/or 1300, described herein at least in relation to FIGS. 3, 9A-9B, 10, 12, and 13, respectively. The sample analysis apparatus 1100 can be included in or otherwise associated with a measurement analysis system that is functionally and/or structurally similar to the measurement analysis system 100 of FIG. 1. For example, in some implementations, the sample analysis apparatus 1100 can include a compute device that is functionally and/or structurally similar to the compute device 110 of FIG. 1 and/or the compute device 201 of FIG. 2. In some implementations, this compute device can include components that are functionally and/or structurally similar to the multimodal analysis components 400 of FIG. 4 and/or the hybrid analysis components 500 of FIG. 5.

The interfaces shown in FIG. 11 can permit configuration of and/or data output from components of the sample analysis apparatus 1100. These components can be functionally and/or structurally similar to, for example, the microscope 320, the multispectral imager 330, the Raman probe 340, the hyperspectral imager 350, the RGB imager 360, and/or the actuator(s) 370, each of FIG. 3.

FIG. 12 shows a view of a sample analysis apparatus 1200 in an operational configuration, the apparatus included in a measurement analysis system, according to an embodiment. The sample analysis apparatus 1200 can be functionally and/or structurally similar to the sample analysis apparatus 300, 900, 1000, 1100, and/or 1300, described herein at least in relation to FIGS. 3, 9A-9B, 10, 11, and 13, respectively. The sample analysis apparatus 1200 can be included in or otherwise associated with a measurement analysis system that is functionally and/or structurally similar to the measurement analysis system 100 of FIG. 1. For example, in some implementations, the sample analysis apparatus 1200 can include a compute device that is functionally and/or structurally similar to the compute device 110 of FIG. 1 and/or the compute device 201 of FIG. 2. In some implementations, this compute device can include components that are functionally and/or structurally similar to the multimodal analysis components 400 of FIG. 4 and/or the hybrid analysis components 500 of FIG. 5.

As described herein at least in relation to FIGS. 9A-9B, the sample analysis apparatus 1200 can have hinged (or otherwise attached) doors, which can be opened and/or removed when the sample analysis apparatus 1200 is in an operational configuration (as opposed to a storage/transport configuration). When in the operational configuration, access can be provided to a sample surface (e.g., functionally and/or structurally similar to the sample surface 380 of FIG. 3), such that a sample can be placed within the sample analysis apparatus 1200 for analysis. Access can also be provided to a modularized component(s) of the sample analysis apparatus 1200. A modularized component can be functionally and/or structurally similar to, for example, the microscope 320, the multispectral imager 330, the Raman probe 340, the hyperspectral imager 350, and/or the RGB imager 360, each of FIG. 3.

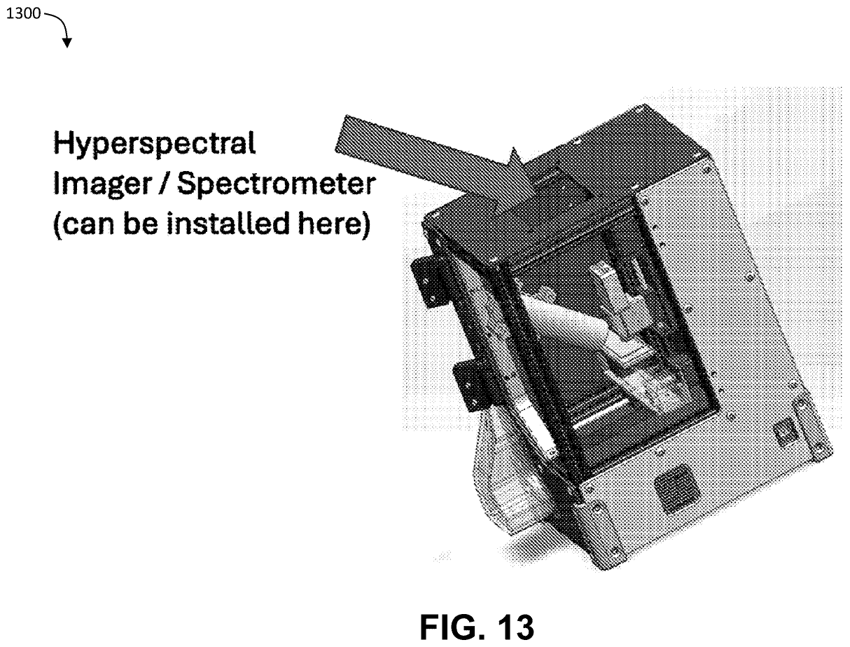

FIG. 13 shows an isometric view of a sample analysis apparatus 1300 included in a measurement analysis system, according to an embodiment. The sample analysis apparatus 1300 can be functionally and/or structurally similar to the sample analysis apparatus 300, 900, 1000, 1100, and/or 1200, described herein at least in relation to FIGS. 3, 9A-9B, 10, 11, and 12, respectively. The sample analysis apparatus 1300 can be included in or otherwise associated with a measurement analysis system that is functionally and/or structurally similar to the measurement analysis system 100 of FIG. 1. For example, in some implementations, the sample analysis apparatus 1300 can include a compute device that is functionally and/or structurally similar to the compute device 110 of FIG. 1 and/or the compute device 201 of FIG. 2. In some implementations, this compute device can include components that are functionally and/or structurally similar to the multimodal analysis components 400 of FIG. 4 and/or the hybrid analysis components 500 of FIG. 5. FIG. 13 more specifically shows a placement option on/within a housing of the sample analysis apparatus 1300 for installation of a hyperspectral imaging spectrometer (e.g., in addition to a Raman spectroscopy component, microscopy component, multispectral imaging component, and/or the like). In some implementations, the sample analysis apparatus 1300 can be configured to accept/interface with at least one modularized component, which can be functionally and/or structurally similar to, for example, the microscope 320, the multispectral imager 330, the Raman probe 340, the hyperspectral imager 350, and/or the RGB imager 360, each of FIG. 3.

While described herein as separate embodiments, in some instances, at least some of the apparatuses 900, 1000, 1100, 1200, and/or 1300 can be related to the same embodiment. For example, in some instances, at least some of FIGS. 9A, 9B, 10, 11, 12, and/or 13 can illustrate different perspective views of the same apparatus (e.g., with a cover of the apparatus installed, with the cover of the apparatus removed, and/or the like).

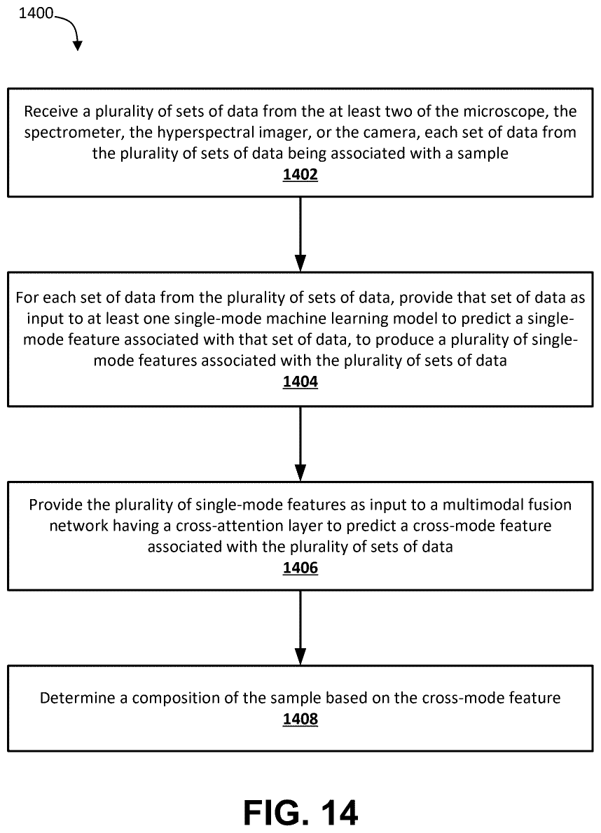

FIG. 14 shows a flow diagram illustrating a method 1400 for determining a composition of a sample based on a cross-mode feature, according to an embodiment. In some instances, the method 1400 can be implemented by a measurement analysis system (e.g., the measurement analysis system 100 of FIG. 1). Portions of the method 1400 can be implemented using a processor (e.g., the processor 220 of FIG. 2) of any suitable compute device (e.g., the compute device 310 of FIG. 3, the compute device 201 of FIG. 2, and/or the compute devices 110 and/or 120 and/or the remote compute device 130 of FIG. 1).

The method 1400 at 1402 includes receiving a plurality of sets of data from the at least two of the microscope, the spectrometer, the hyperspectral imager, or the camera, each set of data from the plurality of sets of data being associated with a sample. For each set of data from the plurality of sets of data, at 1404, that set of data is provided as input to at least one single-mode machine learning model to predict a single-mode feature associated with that set of data, to produce a plurality of single-mode features associated with the plurality of sets of data. The method 1400 at 1406 includes providing the plurality of single-mode features as input to a multimodal fusion network having a cross-attention layer to predict a cross-mode feature associated with the plurality of sets of data. At 1408, a composition of the sample is determined based on the cross-mode feature.

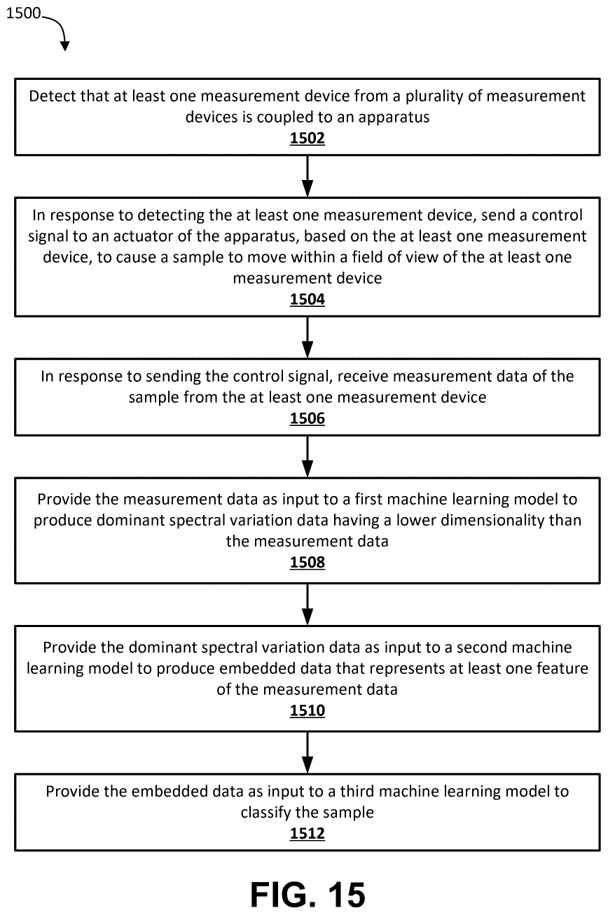

FIG. 15 shows a flow diagram illustrating a method 1500 for classifying a sample based on dominant spectral variation data, according to an embodiment. In some instances, the method 1500 can be implemented by a measurement analysis system (e.g., the measurement analysis system 100 of FIG. 1). Portions of the method 1500 can be implemented using a processor (e.g., the processor 220 of FIG. 2) of any suitable compute device (e.g., the compute device 310 of FIG. 3, the compute device 201 of FIG. 2, and/or the compute devices 110 and/or 120 and/or the remote compute device 130 of FIG. 1).

The method 1500 at 1502 includes detecting that at least one measurement device from a plurality of measurement devices is coupled to an apparatus. In response to detecting the at least one measurement device, the method 1500 at 1504 includes sending a control signal to an actuator of the apparatus, based on the at least one measurement device, to cause a sample to move within a field of view of the at least one measurement device. In response to sending the control signal, at 1506, the method 1500 includes receiving measurement data of the sample from the at least one measurement device. The measurement data is provided as input to a first machine learning model at 1508 to produce dominant spectral variation data having a lower dimensionality than the measurement data. The dominant spectral variation data is provided as input at 1510 to a second machine learning model to produce embedded data that represents at least one feature of the measurement data, and the embedded data is provided as input at 1512 to a third machine learning model to classify the sample.

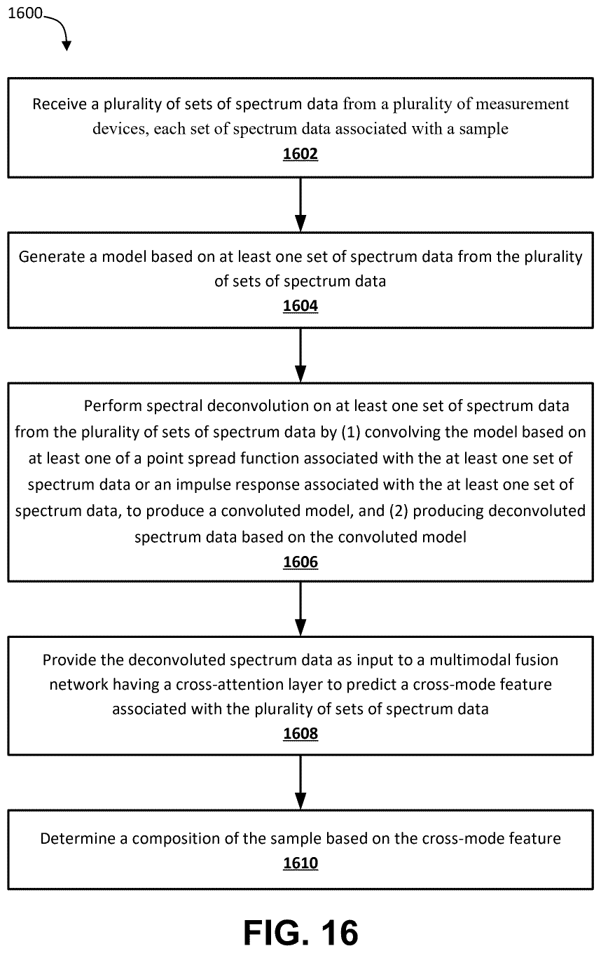

FIG. 16 shows a flow diagram illustrating a method 1600 for determining a composition of a sample based on deconvoluted spectrum data, according to an embodiment. In some instances, the method 1600 can be implemented by a measurement analysis system (e.g., the measurement analysis system 100 of FIG. 1). Portions of the method 1600 can be implemented using a processor (e.g., the processor 220 of FIG. 2) of any suitable compute device (e.g., the compute device 310 of FIG. 3, the compute device 201 of FIG. 2, and/or the compute devices 110 and/or 120 and/or the remote compute device 130 of FIG. 1).

The method 1600 at 1602 includes receiving a plurality of sets of spectrum data from a plurality of measurement devices, each set of spectrum data associated with a sample. At 1604, the method 1600 includes generating a model based on at least one set of spectrum data from the plurality of sets of spectrum data. At 1606, spectral deconvolution is performed on at least one set of spectrum data from the plurality of sets of spectrum data by (1) convolving the model based on at least one of a point spread function associated with the at least one set of spectrum data or an impulse response associated with the at least one set of spectrum data, to produce a convoluted model, and (2) producing deconvoluted spectrum data based on the convoluted model. The deconvoluted spectrum data is provided as input at 1608 to a multimodal fusion network having a cross-attention layer to predict a cross-mode feature associated with the plurality of sets of spectrum data, and a composition of the sample is determined at 1610 based on the cross-mode feature.

Examples of computer code include, but are not limited to, micro-code or micro-instructions, machine instructions, such as produced by a compiler, code used to produce a web service, and files containing higher-level instructions that are executed by a computer using an interpreter. For example, embodiments can be implemented using Python, Java, Javascript, C++, and/or other programming languages and development tools. Additional examples of computer code include, but are not limited to, control signals, encrypted code, and compressed code.

The drawings primarily are for illustrative purposes and are not intended to limit the scope of the subject matter described herein. The drawings are not necessarily to scale; in some instances, various aspects of the subject matter disclosed herein can be shown exaggerated or enlarged in the drawings to facilitate an understanding of different features. In the drawings, like reference characters generally refer to like features (e.g., functionally similar and/or structurally similar elements).

The acts performed as part of a disclosed method(s) can be ordered in any suitable way. Accordingly, embodiments can be constructed in which processes or steps are executed in an order different than illustrated, which can include performing some steps or processes simultaneously, even though shown as sequential acts in illustrative embodiments. Put differently, it is to be understood that such features can not necessarily be limited to a particular order of execution, but rather, any number of threads, processes, services, servers, and/or the like that can execute serially, asynchronously, concurrently, in parallel, simultaneously, synchronously, and/or the like in a manner consistent with the disclosure. As such, some of these features can be mutually contradictory, in that they cannot be simultaneously present in a single embodiment. Similarly, some features are applicable to one aspect of the innovations, and inapplicable to others.

Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Some embodiments described herein relate to a computer storage product with a non-transitory computer-readable medium (also can be referred to as a non-transitory processor-readable medium and/or a machine-readable medium) having instructions or computer code thereon for performing various computer-implemented operations. The computer-readable medium (or processor-readable medium, machine-readable medium, etc.) is non-transitory in the sense that it does not include transitory propagating signals per se (e.g., a propagating electromagnetic wave carrying information on a transmission medium such as space or a cable). The media and computer code (also can be referred to as code) can be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules can include, for example, a processor, a field programmable gate array (FPGA), and/or an application specific integrated circuit (ASIC). Software modules (executed on hardware) can include instructions stored in a memory that is operably coupled to a processor and can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments can be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

What is claimed is:

1. An apparatus, comprising:
a housing that defines an internal volume;
at least two of a microscope, a spectrometer, a hyperspectral imager, or a camera, disposed within the internal volume;
a processor; and
a non-transitory, processor-readable medium operably coupled to the processor and storing instructions that, when executed by the processor, cause the processor to:
receive a plurality of sets of data from the at least two of the microscope, the spectrometer, the hyperspectral imager, or the camera, each set of data from the plurality of sets of data being associated with a sample,
for each set of data from the plurality of sets of data, provide that set of data as input to at least one single-mode machine learning model to predict a single-mode feature associated with that set of data, to produce a plurality of single-mode features associated with the plurality of sets of data,
provide the plurality of single-mode features as input to a multimodal fusion network having a cross-attention layer to predict a cross-mode feature associated with the plurality of sets of data, and
determine a composition of the sample based on the cross-mode feature.

2. The apparatus of claim 1, wherein:
the at least two of the microscope, the spectrometer, the hyperspectral imager, or the camera include the spectrometer; and
a set of data from the plurality of sets of data includes at least one of ultraviolet-visible (UV-Vis) spectrum data, fluorescence spectrum data, infrared (IR) spectrum data, Fourier transform infrared (FTIR) spectrum data, near-infrared (NIR) spectrum data, mid-infrared (MIR) spectrum data, far-infrared (FIR) spectrum data, or x-ray spectrum data.

3. The apparatus of claim 1, wherein the single-mode machine learning model includes a convolutional neural network.

4. The apparatus of claim 1, wherein the non-transitory, processor-readable medium further stores instructions to cause the processor to:
generate a model based on at least one set of data from the plurality of sets of data; and
perform spectral deconvolution on the at least one set of data based on the model to produce deconvoluted data, the cross-mode feature being predicted based on the deconvoluted data.

5. The apparatus of claim 1, wherein the non-transitory, processor-readable medium further stores instructions to cause the processor to:
perform source attribution of the sample based on the cross-mode feature representing at least one of a synthesis route indicator, a cutting agent signature, a trace element profile, an isotopic ratio, a crystal morphology, a tablet pressing pattern, a microscopic surface feature, or a packaging material characteristic.

6. The apparatus of claim 1, wherein:
the apparatus includes at least one actuator; and
the non-transitory, processor-readable medium further stores instructions to cause the processor to:
detect the at least two of the microscope, the spectrometer, the hyperspectral imager, or the camera, and
send a control signal to the at least one actuator, based on the detected at least two of the microscope, the spectrometer, the hyperspectral imager, or the camera, to cause the at least one actuator to move the sample to within a field of view of the at least two of the microscope, the spectrometer, the hyperspectral imager, or the camera.

7. A non-transitory, processor-readable medium storing instructions that, when executed by a processor, cause the processor to:
detect that at least one measurement device from a plurality of measurement devices is coupled to an apparatus;
in response to detecting the at least one measurement device, send a control signal to an actuator of the apparatus, based on the at least one measurement device, to cause a sample to move within a field of view of the at least one measurement device;
in response to sending the control signal, receive measurement data of the sample from the at least one measurement device;
provide the measurement data as input to a first machine learning model to produce dominant spectral variation data having a lower dimensionality than the measurement data;
provide the dominant spectral variation data as input to a second machine learning model to produce embedded data that represents at least one feature of the measurement data; and
provide the embedded data as input to a third machine learning model to classify the sample.

8. The non-transitory, processor-readable medium of claim 7, wherein:
the at least one measurement device includes a Raman spectrometer; and
the measurement data includes Raman spectrum data produced by the Raman spectrometer.

9. The non-transitory, processor-readable medium of claim 7, wherein:
the first machine learning model is configured to perform principal component analysis (PCA).

10. The non-transitory, processor-readable medium of claim 7, wherein:
the second machine learning model includes an autoencoder having a convolutional layer.

11. The non-transitory, processor-readable medium of claim 7, wherein:
the third machine learning model includes a convolutional neural network (CNN).

12. The non-transitory, processor-readable medium of claim 7, wherein:
the third machine learning model includes a support vector machine (SVM) having a radial basis function (RBF) kernel.

13. The non-transitory, processor-readable medium of claim 7, wherein the actuator includes an X-Y table.

14. The non-transitory, processor-readable medium of claim 7, wherein the actuator includes a vertically oriented linear actuator coupled to a sample surface, the sample being disposed on the sample surface.

15. The non-transitory, processor-readable medium of claim 7, wherein the plurality of measurement devices includes at least two of a microscope, a spectrometer, a hyperspectral imager, or a camera.

16. The non-transitory, processor-readable medium of claim 7, further storing instructions to cause the processor to:
split the embedded data into training data and validation data, based on a predetermined number of folds; and
perform k-fold cross-validation on the third machine learning model across the predetermined number of folds and based on the training data and validation data, to finetune at least one of a learning rate, a regularization term, or a kernel parameter, associated with the third machine learning model.

17. The non-transitory, processor-readable medium of claim 7, wherein:
the sample includes a pathogen; and
the instructions to cause the processor to classify the sample include instructions to cause the processor to determine if the pathogen is antibiotic-resistant.

18. The non-transitory, processor-readable medium of claim 7, wherein:
the sample includes a plurality of pathogen cells that have been washed and placed onto a gold-coated slide.

19. An apparatus, comprising:
a plurality of measurement devices associated with a plurality of spectra, each measurement device from the plurality of measurement devices being associated with a spectrum different from remaining spectra from the plurality of spectra; and
a non-transitory, processor-readable medium storing instructions that, when executed by a processor, cause the processor to:
receive a plurality of sets of spectrum data from the plurality of measurement devices, each set of spectrum data from the plurality of sets of spectrum data associated with a sample;
generate a model based on at least one set of spectrum data from the plurality of sets of spectrum data;
perform spectral deconvolution on at least one set of spectrum data from the plurality of sets of spectrum data by:
convolving the model based on at least one of a point spread function associated with the at least one set of spectrum data or an impulse response associated with the at least one set of spectrum data, to produce a convoluted model, and
producing deconvoluted spectrum data based on the convoluted model;
provide the deconvoluted spectrum data as input to a multimodal fusion network having a cross-attention layer to predict a cross-mode feature associated with the plurality of sets of spectrum data; and
determine a composition of the sample based on the cross-mode feature.

20. The apparatus of claim 19, wherein the non-transitory, processor-readable medium further stores instructions to cause the processor to:
perform source attribution of the sample based on the cross-mode feature representing at least one of a synthesis route indicator, a cutting agent signature, a trace element profile, an isotopic ratio, a crystal morphology, a tablet pressing pattern, a microscopic surface feature, or a packaging material characteristic.

21. The apparatus of claim 19, wherein the instructions to cause the processor to generate the model include instructions to cause the processor to:
generate, based on the at least one set of spectrum data, the model that represents at least one of a Gaussian shape or a Lorentzian shape.
